(19) United States
(12) Patent Application Publication
(10) Pub. No.: US 2025/0243593 A1
(43) Pub. Date: Jul. 31, 2025

(54) OXYGEN-SELECTIVE ANODES

(71) Applicant: The Regents of the University of California, Oakland, CA (US)

(72) Inventors: Gaurav Sant, Los Angeles, CA (US); Dante Adam Simonetti, Los Angeles, CA (US); Xin Chen, Los Angeles, CA (US); David Jassby, Los Angeles, CA (US); Erika Callagon La Plante, Los Angeles, CA (US); Steven Bustillos, Los Angeles, CA (US); Thomas J. Traynor, Los Angeles, CA (US)

(21) Appl. No.: 19/041,375

(22) Filed: Jan. 30, 2025

Related U.S. Application Data
(62) Division of application No. 18/429,054, filed on Jan. 31, 2024, now Pat. No. 12,247,303.
(60) Provisional application No. 63/442,298, filed on Jan. 31, 2023.

(51) Int. Cl. C25B 11/077; B01D 53/32; B01D 53/62; C01G 51/40; C01G 55/00; C25B 1/14; C25B 11/075

(52) U.S. Cl. CPC C25B 11/0775; B01D 53/326; B01D 53/62; C01G 51/40; C01G 55/00; C25B 1/14; C25B 11/075; B01D 2257/504; C01P 2002/52; C01P 2004/84; C01P 2006/40

(57) ABSTRACT

The present disclosure relates to oxygen-selective anodes and methods for the use thereof.

### CROSS-REFERENCE TO RELATED APPLICATIONS

This application claims the benefit of priority to U.S. Provisional Application No. 63/442,298, filed Jan. 31, 2023, the contents of which are herein incorporated by reference in their entirety.

### STATEMENT OF GOVERNMENT SUPPORT

This invention was made with government support under DE-AR0001551 awarded by the U.S. Department of Energy. The government has certain rights in the invention.

### BACKGROUND

Efficient and cost-effective means of sequestering CO₂, such as by mineralization, are highly desired as a critical component of combating global climate change. Alkaline solutions are known to react with CO₂ sources to produce HCO₃⁻ and CO₃²⁻ species, which may be isolated dissolved species, or as stable solids, but there are a number of challenges to large-scale CO₂ sequestration using alkaline solutions including cost of the alkalinizing reagents. As an alternative, alkaline solutions may be prepared efficiently using water electrolysis, and separation of the resultant H⁺ (acidic) and OH⁻ (basic) species into acidic and basic solutions. However, the chlorine evolution reaction (ClER) occurs favorably in solutions comprising Cl⁻ ions, such as naturally occurring brines or seawater. The undesired ClER occurring in competition with the desired oxygen evolution reaction (OER) hinders the development of such processes for large-scale CO₂ capture and removal. As such, there exists a need for electrolytic systems for CO₂ capture and removal which mitigate the unwanted production of free chlorine species and chlorine gas.

### SUMMARY OF THE INVENTION

In certain aspects, provided herein are oxygen-selective anodes. In further aspects, provided herein are methods of electrolyzing saline solutions, wherein an oxygen-selective anode (OSA) is employed.

### BRIEF DESCRIPTION OF THE DRAWINGS

FIG. 1 shows a simplified block flow diagram showing saline water electrolysis as a carbon removal pathway.

FIG. 2 shows the acid neutralization capacity (mol H⁺/kg solute) of various exemplary deacidifying agents of the disclosure, established on the basis of their chemical composition. In general, a smaller quantity (mass) of solute is used as acid neutralization capacity increases.

FIG. 3 shows the dechlorination capacity (mol Cl₂/kg solute) of various dechlorinating agents of the disclosure, established on the basis of their chemical composition. In general, a smaller quantity (mass) of solute is used as dechlorination capacity increases.

FIG. 4 shows a schematic drawing, in a cross-sectional view, of an exemplary flow-through, single-compartment electrolyzer.

FIG. 5 shows the pH of each of the effluents recorded at various time points from the system shown in FIG. 4.

FIG. 6 shows the chemical composition of the precipitated solids from the cathodic chamber of the system shown in FIG. 4.

FIG. 7 shows the inorganic carbon (IC, e.g., HCO₃⁻, CO₃²⁺) concentration over time by continuously aerating the catholyte and cathodic chamber with 400 ppm CO₂ gas mixture.

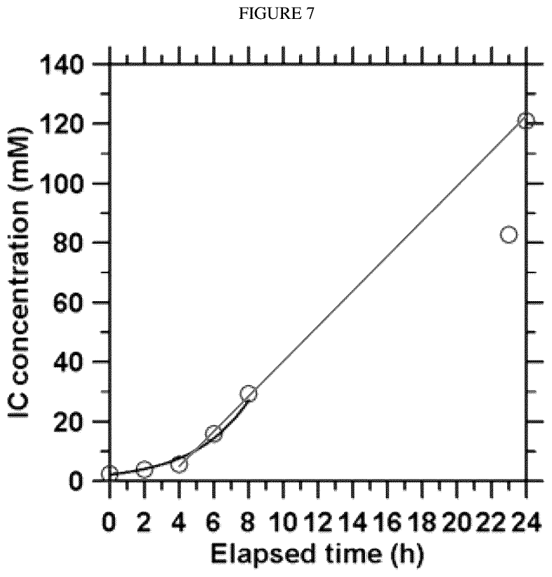

FIG. 8 shows the concentration of chlorine in the anolyte over time, and (inset) an exemplary Mn oxide-coated anode.

FIG. 9 shows the results of an exemplary continuously stirred reactor experiment using Forsterite-olivine and a hydraulic retention time of 10 minutes at varying solid/liquid ratios (50, 125, 250 g/L) with an acidified seawater (initial pH=2).

FIG. 10 shows exemplary coating of an Ir—Sn MMO (white) on a Ti substrate (gray) with approximate thickness of the MMO layer shown.

FIG. 11 shows exemplary coating of a Mn oxide outer layer (gray) on top of a Ir—Sn MMO layer (dark gray/black) with approximate thickness of the Mn oxide layer shown.

FIG. 12 shows exemplary coating of an Ir—Ta MMO (white) on a Ti substrate (gray) with approximate thickness of the MMO layer shown.

FIG. 13 shows exemplary coating of a Mn oxide outer layer (darker gray, in focus) on the Ir—Ta MMO surface (lighter gray, out of focus) with approximate thickness of the Mn oxide layer shown.

FIG. 14 shows exemplary surface morphology of the surface of an Ir—Sn MMO layer.

FIG. 15 shows exemplary surface morphology of the surface of an Ir—Ta MMO layer.

FIG. 16 shows exemplary surface morphology of the surface of a Mn oxide outer layer.

FIG. 17 shows exemplary surface morphology at high magnifications of the Mn oxide outer layer.

FIG. 18 shows exemplary surface morphology and roughness of the Mn oxide outer layer.

FIG. 19 shows schematic drawing of the exemplary arrangement of the Ti substrate, MMO inner layer and the Mn oxide outer layer.

FIG. 20 shows X-Ray diffraction (XRD) phase analysis of the Ti substrate, Ir—Ta MMO inner layer and the Mn oxide outer layer.

FIG. 21 shows testing of an exemplary oxygen-selective anode (comprising a TaIrOx MMO layer) of the disclosure in a representative electrolyzer cell.

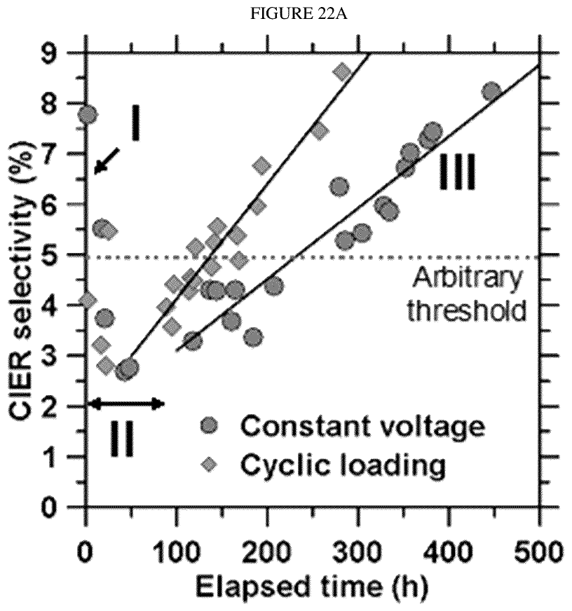

FIG. 22A shows Accelerated Lifetime Testing (ALT) performance of exemplary anodes based on anode substrate 2 under constant and cyclic voltage conditions. Three distinguished stages were revealed by the ALT tests, including stabilization (stage I), stabilized (stage II), and linear degradation (Stage III).

FIG. 22B shows ClER selectivity changes under the cyclic voltage loading over the course of 150 h.

FIG. 22C shows ALT performance of PGM-based anodes with different substrates under constant voltage. The anode with the higher substrate Ir loading (anode substrate 3) showed significantly better performance as compare to anode substrate 2, which had a lower substrate Ir loading.

FIG. 22D demonstrates that, as observed in ClER evolution, longer stage II duration correlated with slower degradation rates observed in stage III. The ALT experiments were conducted in a flow-through electrolyzer with 0.5M NaCl as electrolyte.

FIG. 23A shows SEM images of the surfaces of exemplary MnOx-coated PGM-based electrodes (with anode substrate 2) plated in 0.6 M H₂SO₄ (top) or 2 M H₂SO₄ (bottom).

FIG. 23B shows ALT performances of the MnOx-coated PGM-based electrode (anode substrate 2) plated in either 0.6 M H₂SO₄ or 2 M H₂SO₄.

FIGS. 24A and 24B show the ClER selectivity (24A) and cell voltage (24B) obtained from ALT durability experiments of PGM-free electrodes electroplated at various H₂SO₄ concentrations and various processes.

### DETAILED DESCRIPTION OF THE INVENTION

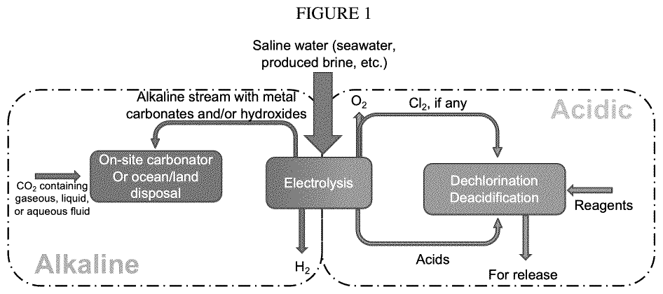

Electrochemical saline water alkalinization is a transformative approach for CO₂ removal. For instance, seawater electrolysis-mediated carbon immobilization exploits: (i) the ocean-atmosphere equilibrium of gas-phase and dissolved CO₂ (e.g., ˜2 mM dissolved inorganic carbon (DIC)), and (ii) the large abundance of divalent alkaline cations in seawater (e.g., 55 mM Mg²⁺ or 10.5 mM Ca²⁺). These attributes can be leveraged to electrochemically force carbonate and hydroxide mineral formation (e.g., Ca-, Mg-carbonates, hydroxides, and their variants), which consumes dissolved CO₂ and absorbs additional atmospheric CO₂ as carbonates/bicarbonates. Electrolytic alkalinization may be affected without the need for costly alkali additives (e.g., NaOH), but instead by the electrochemical pH-swing of saline water in the proximity of flow-through electrode surfaces that produce hydroxide ions (OH⁻) and promote heterogeneous and homogeneous nucleation and growth of carbonate and hydroxide mineral precipitates. However, saline water electrolysis is usually accompanied by the oxidation of chloride ions and the formation of free chlorine species (e.g., Cl₂, ClO⁻, or HClO), which occurs on the anode. Unless these species can be collected prior to discharge of electrolyzer effluents, chlorine oxidation is in general harmful and should be suppressed. Herein are provided methods and systems for the immobilization of CO₂ as solid and aqueous carbonate and bicarbonate species while inhibiting chloride ion oxidation reactions via 1) upstream strategies such as using oxygen evolution reaction (OER)-selective anodes, and/or 2) down-stream strategies such as chlorine scavenging processes. An exemplary, simplified flow diagram is denoted in FIG. 1, and the detailed strategies are respectively established on the catholyte (alkaline) and anolyte (acidic) sides.

Direct seawater electrolysis selective against unwanted ClER, has been attempted and reported over the years. In summary, ClER suppression is generally enabled by designing anode catalysts following two pathways: 1) low-overpotential anodes that can be operated below the ClER kick-off potential, and 2) Cl⁻-blocking anodes that screen Cl⁻ from the water-splitting surface.

The low-overpotential anodes take advantage of the fact that ClER (Equation 1) requires a slightly higher thermodynamic (TD) potential than the desired OER (Equation 2) to take place.

OER: H₂O→1/2O₂+2H⁺+2e⁻, E_{OER}⁰=1.23 V (1)

ClER: 2Cl⁻+2e⁻→Cl₂, E_{ClER}⁰=1.35 V (2)

At the seawater Cl⁻ concentration (˜0.5M), the TD potentials of ClER and OER exhibit a gap of ˜0.2-0.3 V at an acidic pH of 0-3. This gap is maximized at pH>7.5 to ˜0.48 V. Although metal oxide electrocatalysts have been developed that show promising overpotentials, such a pathway is limited by low current densities (i.e., <10 A/m²), and only neutral to alkaline pHs. When used in acidic conditions, most of the metal oxides are unstable. Additionally, due to the reduction in potential gaps to <0.3 V, the overpotential of even PGM catalysts (platinum group metals, e.g., IrOx) is too high to permit OER selectivity.

Alternatively, a Cl⁻-blocking anode is achieved by double-layered coatings, e.g., by overlaying a Cl⁻-blocking on an OER-catalyzing layer. The Cl⁻-blocking outer layer usually comprises negatively charged materials that repel the negatively charged Cl⁻ ion, while letting water, oxygen, and cationic species (Na⁺, H⁺, etc.) pass through the outer layer to the active layers beneath. A number of anodes have been demonstrated to possess high OER-selectivity, most of which contain a Cl⁻-blocking overlayer composed of Manganese oxides (MnOx). Others use Nafion or Si- and Ni-hydroxides which play a similar Cl⁻ blocking role to MnOx.

TABLE 1
Compositions and relevant properties of other known anodes.

| | Catalysts summary | OER | | | Acid | Cl⁻ |
|---|---|---|---|---|---|---|
| | (substrate/inner layer/ | selectivity | | | addition | addition |
| Ref | outer layer) | (%) | Durability | Electrolyte | (Y/N) | (Y/N) |
| 4 | Ti/SnIrOx/ | 99 | 4000 h @ | 0.5 m NaCl | Y | Y |
| | MnMoSnOx | | 1000 A/m² | at pH 1 | | |
| 5 | Ti/SnIrSbOx/ | 98 | 3400 h @ | 0.5 m NaCl | Y | Y |
| | MnMoSnOx | | 1000 A/m² | at pH 2 | | |
| 6 | Ti/IrO₂/MnMoOx | 96.5 | 2800 h @ | 0.5M NaCl | N | Y |
| | | | 1000 A/m² | pH 8 | | |
| 7 | Ti/IrO₂/MnMoWOx | 99 | 2600 h @ | 0.5M NaCl | N | Y |
| | | | 1000 A/m² | pH 8.7 | | |
| 8 | Ti/SnIrSbOx/ | 97.5 | 2400 h @ | 0.5M NaCl | N | Y |
| | Mn_{0.92}Mo_{0.07}Sn_{0.01}O_{2.07} | | 1000 A/m² | | | |
| 9 | Ti/IrO₂/MnMoSnOx | 94 | 2000 h @ | 0.5M NaCl | N | Y |
| | | | 1000 A/m² | pH 8.7 | | |
| 10 | Ti/IrO₂/ | 99.7 | 800 h @ | 0.5M NaCl | N | Y |
| | Mn_{0.8}Mo_{0.05}W_{0.06}O_{2.11} | | 1000 A/m² | pH 8 | | |
| 11 | Ti/IrO₂/MnMoWOx | >99 | 192 h @ | 0.5 m NaCl | Y | Y |
| | | | 1000 A/m² | at pH 2 | | |
| 12 | IrOx/SrIrO₃ | N.A. | 30 h @ | 0.5M H₂SO₄ | Y | N |
| | | | 100 A/m² | | | |
| 13 | Ti/PtPd | N.A. | 12 h @ | Seawater | N | N |
| | | | 1000 A/m² | | | |
| 14 | Pt coated with Si | N.A. | 12 h @ | 0.5M | N | Y |
| | | | 2 A/m² | KHSO₄ + 0.6M KCl | | |
| 15 | GC/IrO₂/Nafion | 100 | 0.5 h @ | 0.5M NaCl | N | Y |
| | | | 5000 A/m² | pH 8.3 | | |
| 16 | HF treated Ti/ | 99 | 430 h @ | 0.5 m NaCl | Y | Y |
| | Sn_{0.16}Ir_{0.84}O₂/ | | 2000 A/m² | at pH 1 | | |
| | Mn_{0.929}Mo_{0.067}Sn0_{0.004}O_{2.067} | | | | | |
| 17 | Ti/IrO₂/MnWOx | 99.6 | N.A. | 0.5M NaCl | N | Y |
| | | | | 0.01M NaOH | | |
| | | | | for alternate | | |
| | | | | the pH to 8 | | |
| 18 | Ti/IrO₂/MnWOx | 70 | N.A. | 0.5M NaCl | N | Y |
| | | | | 0.01M NaOH | | |
| | | | | for alternate | | |
| | | | | the pH to 8 | | |
| 19 | Ti/IrO₂/MnZnOx | 86 | N.A. | 0.5M NaCl | N | Y |
| | | | | 0.01M NaOH | | |
| | | | | for alternate | | |
| | | | | the pH to 8.3 | | |
| 20 | GC/IrO₂/MnOx | 82 | N.A. | 30 mM Cl⁻ | N | Y |
| 21 | Ti/MnO₂ | N.A. | N.A. | Seawater | N | Y |
| 22 | GC/PdRuOx pyrochlore + | 68 | N.A. | 0.6M NaCl | N | Y |
| | Nafion | | | | | |

Although the compatibility of the Cl⁻-blocking layer and the OER-catalyzing layer is important, the anode's durability and overpotential are based on the underlying OER catalyst. As indicated in Table 1, the most durable anodes generally rely on a heavy loading of IrOx, which can lastingly endure acidic and chlorinated environments. For instance, either pure IrO₂ or a IrO₂ contents >80 at. % (>90 wt. %) is needed to ensure the longevity of the anodes. However, the tightening of global Ir production and price presents a barrier to large-scale production and use of these anodes. Therefore, there is a strong incentive to replace Ir (and PGMs in general) with elements that are cheap and abundant, while maintaining the durability in both chlorinated and acidic environments seen in PGM-based electrodes. Some PGM-free metal oxides have been studied which can potentially endure an acidic environment but exhibit poor durability in high-chlorine environments (Table 2).

TABLE 2
PGM-free, ER-selective catalysts from literature reports

| | Catalysts | | | Acid | Cl⁻ |
|---|---|---|---|---|---|
| Ref | summary | Durability | Electrolyte | addition | addition |
| 25 | MnOx | 8000 h @ | pH 2 | Y | N |
| | | 100 A/m² | H₂SO₄ | | |
| 26 | MnOx | 500 h @ | 0.5M H₂SO₄ | Y | N |
| | | 100 A/m² | | | |
| 27 | CoMnOx | 1500 h @ | pH 1 | Y | N |
| | | 2000 A/m² (pH 1 | H₃PO₄/H₂SO₄ | | |
| | | H₃PO₄) | | | |
| | | 200 h @ | | | |
| | | 1000 A/m² (pH 1 | | | |
| | | H₂SO₄) | | | |
| 28 | NiMnSbOx | 168 h @ | 1.0M H₂SO₄ | Y | N |
| | | 100 A/m² | | | |
| 29 | Co₃O₄ | 86.8 h @ | 0.5M H₂SO₄ | Y | N |
| | | 1000 A/m² | | | |
| 30 | CoFePbOx | 50 h @ 10 A/m² | pH 2 H₂SO₄ | Y | N |
| 31 | CoFeOx | 50 h @ 100 A/m² | H₂SO₄ pH 0.3 | Y | N |
| 32 | Co₃O₄ | 40 h @ 100 A/m² | 1M H₂SO₄ | Y | N |
| 33 | Fe₂O₃ | 24 h @ 100 A/m² | 0.5M H₂SO₄ | Y | N |
| 34 | NiCo-DEA | 12 h @ 100 A/m² | Seawater | N | Y |
| 35 | CoFe layered double | 8 h @ 100 A/m² | Sea salt pH 8 | N | Y |
| | hydroxide (LDH) | | | | |
| 36 | MnCoOx | 6 h @ 100 A/m² | 0.25M MgCl₂ | N | Y |
| | | | solution | | |
| 37 | MnSbOx | N.A. | 1M H₂SO₄ | Y | N |
| 38, | MnOx | N.A. | | Y | N |
| 39 | | | | | |
| 40 | MnO₂ | N.A. | 0.05M H₂SO₄ | Y | N |
| 41 | Co₂TiO₄ | N.A. | 0.5M H₂SO₄ | Y | N |
| 42 | Mn₅Si₃ | N.A. | 1.63M H₂SO₄ | Y | N |
| 35 | Co—Fe LDH | N.A. | Simulated | N | Y |
| | | | seawater | | |
| 43 | Co—Se | N.A. | Seawater | N | Y |

The presence of Cl⁻ in the solution is apparently detrimental and causes decomposition of PGM-free oxide catalysts and thus a substantially reduced lifetime. Adding a Cl⁻-blocking outer layer (e.g., coating) may, therefore protect PGM-free catalysts from Cl⁻ and allow for longer lifetimes and/or better performance.

Therefore, anodes with a double-layer coating could solve these OER-selectivity and stability challenges. Electrodes of the disclosure a described below in two categories: PGM-based and PGM-free electrodes.

### PGM-Based Electrodes

To realize IrOx-based OER-selective anodes, literature sources report a >80% IrO₂ loading, which is costly and therefore challenging to commercialize. Therefore, in certain embodiments, oxygen-selective anodes of the disclosure comprise TaIr-oxides (TaIrOx doped with Ru, Sn, and Zn oxides, see Table 3)-coated electrodes comprising a Ti core (e.g., a Ti plate or Ti mesh, Table 3). A manganese oxide (MnOx) layer was applied to achieve OER selectivity, for example according to the procedure in Example 3. Three TaIrOx-coated substrates with unique compositions and low Ir-loadings were fabricated and analyzed. The results of these analyses are shown in Table 3.

TABLE 3
Summary of selected anodes with MMO (TaIrOx doped with
Ru, Sn, and Zn oxides, see Table 3) described herein.

| Anode Substrate No. | 1 | | 2 | | 3 | |
|---|---|---|---|---|---|---|
| Substrate | Ti plate | | Ti plate | | Expanded Ti mesh | |
| Coating thickness | >5 um | | >5 um | | >5 um | |
| Ir loading | 22 g/m² | | 5 g/m² | | 15 g/m² | |
| Estimated lifetime | 5 years @ <1000 | | 5 years @ <1000 | | 5 years @ <1000 | |
| | A/m² | | A/m² | | A/m² | |
| Composition (EDS) | atomic % (at %) | at % error | at % | at % error | at % | at % error |
| O | 64.82 | 0.33 | 68.20 | 0.21 | 72.67 | 0.58 |
| Ti | 3.91 | 0.09 | 5.15 | 0.07 | 1.24 | 0.16 |
| Ru | — | — | — | — | 1.28 | 0.07 |
| Sn | 7.29 | 0.15 | — | — | — | — |
| Zn | — | — | 4.01 | 0.03 | — | — |
| Ta | 15.46 | 0.10 | 12.15 | 0.05 | 7.77 | 0.20 |
| Ir | 5.77 | 0.08 | 7.03 | 0.04 | 17.05 | 0.68 |
| Total | 97.25 | 0.75 | 96.54 | 0.40 | 100.00 | 1.68 |

| | | | |
|---|---|---|---|
| Coating IrO₂ | 17.8 at % | 24.8 at % | 62.4 at % |
| content | | | |

Anode 1 (17.8 at % IrO₂ loading) coated with MnOx was tested in an exemplary flow-through electrolyzer with simulated seawater (Instant Ocean Seawater: IOSW). ClER selectivity was determined by measuring the free-chlorine concentration in anolyte effluents using a UV-vis spectrometer. At operational current densities (e.g., 300 A/m²), the ClER selectivity remains below 3% (i.e., OER>97%) under a cyclic voltage condition. No significant indication of degradation was observed over the testing period, and cell voltage remains unchanged, highlighting the stability of the TaIrSnOx layer.

### Accelerated Lifetime Tests (ALT)

Accelerated lifetime tests were carried out by applying a higher current density (1000 A/m²) as compared to more typical operational current density (300 A/m²). Importantly, a well-established equation (Equation 3) can be the used to estimate service lifetime using the duration measured in ALTs:

$$Predicted life = {( \frac{{J}_{ALT}}{{J}_{op}} )}^{1.7} \times ALT life \qquad ( 3 )$$

where J_{ALT} is the current density used in accelerated lifetime tests (e.g., 1000 A/m²), Jₒₚ is the operation current density (e.g., 300 A/m²), and the exponent of 1.7 is an empirical constant. Therefore, Equation 4 yields:

$$Predicted life = 7.74 \times ALT life \qquad ( 4 )$$

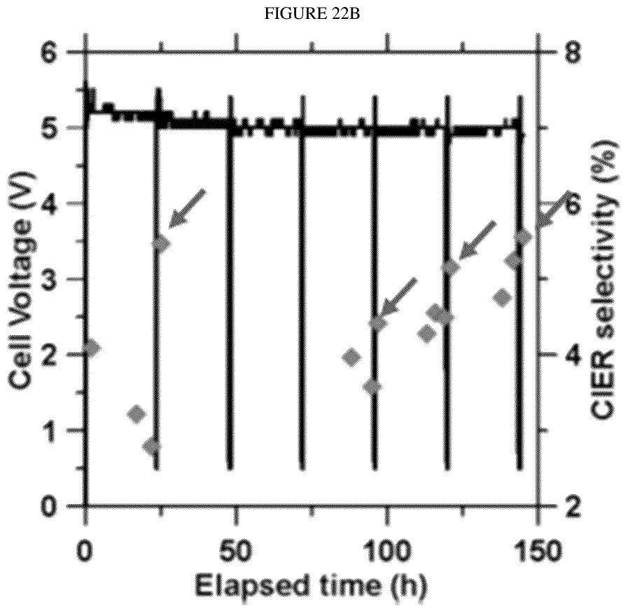

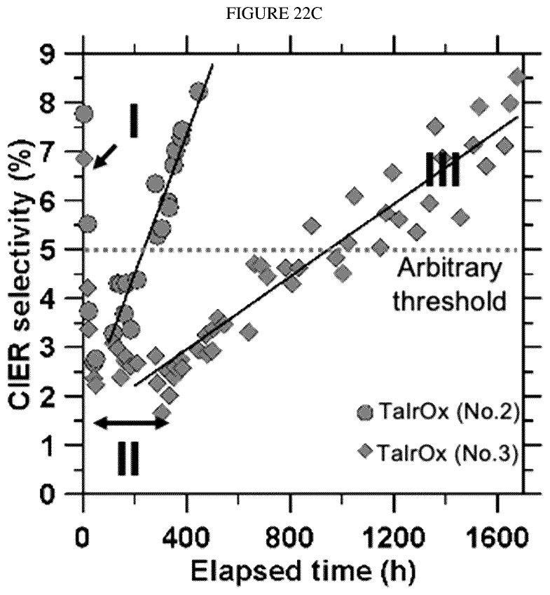

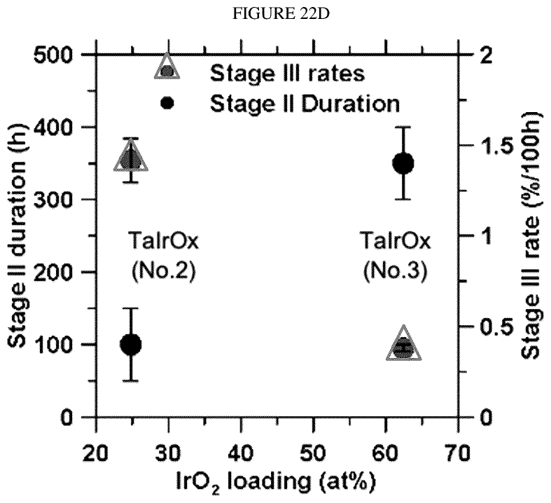

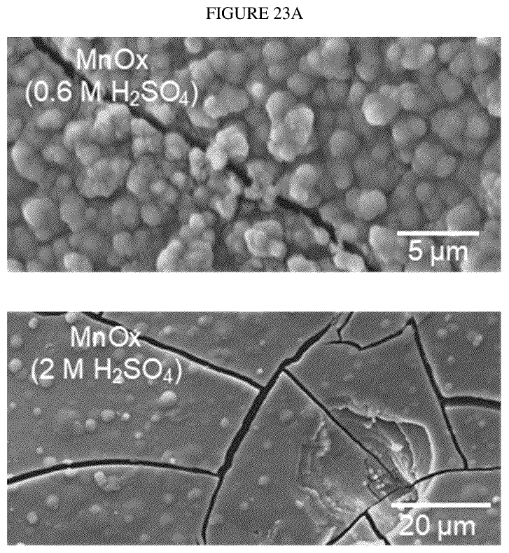

Using ALT, the impacts of cyclic or constant voltage loading conditions on the predicted lifetime were examined (FIG. 22A). Interestingly, there are typically three stages observed in ALTs. The ClER selectivity drops at the initial 24-48 hours (stage I), this is usually accompanied by the cell potential reduction (FIG. 22B) likely due to hydrolysis and stabilization of MnOx in the ionic (H⁺, Na⁺) environment. The low ClER selectivity is maintained for a short period (stage II), and then increases at a constant rate (stage III). As observed, stage I is generally similar for all experiments whereas stage II-III characterizes the electrode durability and depends on the specific composition of the electrode. For instance, when the anode is subjected to cyclic voltage loading, the duration of stage II was shorter and the degradation rate in stage III was faster. Notably, cyclic loading induces a significant reduction in lifetime (˜40%), and the selectivity failure was preceded by the progressive upsurge of ClER selectivity after every voltage cycle (see FIG. 22B), which appeared to have disrupted the stabilization of MnOx. When the current is turned on and off, the anode surface was switched between H⁺-rich to Na⁺-rich ionic environments, leading to a structural change of MnOx between hydrogenated and Na-enriched forms. Consequently, structural damage is likely to occur in the MnOx layer resulting in a shortened life. Failure analysis at the end of each experiment revealed the degraded MnOx layer as the origin of lost ClER selectivity.

Furthermore, substrate dissolution may also cause MnOx detachment and OER selectivity loss. Although it is slow, the dissolution of only a few atomic layers of the TaIrOx can induce debonding between the two layers. In addition, cyclic loading also promotes reconstruction of the substrate's crystalline structure, leading to accelerated debonding between TaIrOx and MnOx layers. Therefore, substrate renewal becomes more important to mitigate the debonding issues and to prolong the OER-selective lifetime.

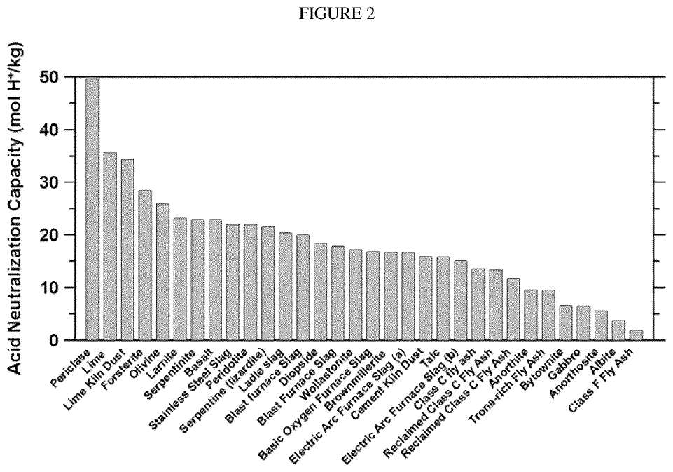

A second set of ALTs aims to evaluate the impacts of the substrate's IrO₂ loading. Testing was performed for the TaIrOx substrate from anode 2 (24.8 at % IrO₂) and anode 3 (62.4 at % IrO₂) under the constant voltage condition. As indicated in FIGS. 22C and 2D, a higher IrO₂ content in anode 3 not only prolongs the duration of stage II but also reduced the degradation rate observed in stage III.

In certain embodiments, the MMO layer comprises Ta, Ir, and O. In certain embodiments, the first metal oxide comprises Ta, and the second metal oxide comprises Ir. In some embodiments, the MMO layer comprises Sn, Ir, and O. In certain embodiments, the first metal oxide comprises Sn, and the second metal oxide comprises Ir. In some embodiments, the MMO layer comprises Co, Mn, and O. In certain embodiments, the first metal oxide is Co, and the second metal oxide is Mn. In certain embodiments, the MMO layer further comprises a dopant selected from Ta, Co, and Nb, or a combination thereof.

In certain embodiments, the MMO layer comprises from about 5 atomic % (at. %) Ir to about 65 at. % Ir. In further embodiments, the MMO layer comprises from about 15 at. % Ir to about 30 at. % Ir. In certain preferred embodiments, the MMO layer comprises about 5.77 at. % Ir. In other preferred embodiments, the MMO layer comprises about 7.03 at. % Ir. In some embodiments, the MMO layer comprises from about 17 at. % Ir to about 65 at. % Ir. In certain preferred embodiments, the MMO layer comprises about 62.4 at. % Ir.

In some embodiments, the outer layer further comprises an outer layer dopant. In certain embodiments, the outer layer further comprises two or more outer layer dopants. In certain preferred embodiments, each of the outer layer dopants is a transition metal. In some preferred embodiments, the outer layer dopant is selected from a transition metal oxide, a transition metal hydroxide, and transition metal oxyhydroxide.

In certain embodiments, the outer layer is coated on the surface of the MMO layer. In some embodiments, the outer layer is coated in-mix (e.g., intermingled) with the MMO layer.

In certain embodiments, the MMO layer comprises one or more additional MMO layers. In some embodiments, the MMO layer comprises 1 additional MMO layer. In certain embodiments, the MMO layer comprises 2 additional MMO layers. In some embodiments, the MMO layer comprises 3 additional MMO layers. In certain embodiments, the MMO layer comprises 4 additional MMO layers. In some embodiments, the MMO layer comprises 5 additional MMO layers. In certain embodiments, the additional MMO layer(s) comprises an element selected from groups 3, 4, 5, 6, 7, 8, 9, 10, 11, 12, 13, and 14. In further embodiments, the additional MMO layer(s) comprises a metal oxide comprising Ta, Ru, Ti, Y, Sr, Sn, La, Ce or Ir. In certain preferred embodiments, the additional MMO layer(s) has a composition as defined in the present disclosure.

In certain embodiments, the substrate is contacted with the MMO layer at a substrate-MMO junction, and the MMO layer is contacted with the outer layer at a MMO-outer layer junction. In some embodiments, the substrate-MMO junction is substantially flat. In other embodiments, the substrate-MMO junction is substantially rough. In some embodiments, the substrate-MMO junction is a bulk heterojunction. In certain embodiments, the MMO-outer layer junction is substantially flat. In other embodiments, the MMO-outer layer junction is substantially rough. In certain embodiments, the MMO-outer layer junction is a bulk heterojunction.

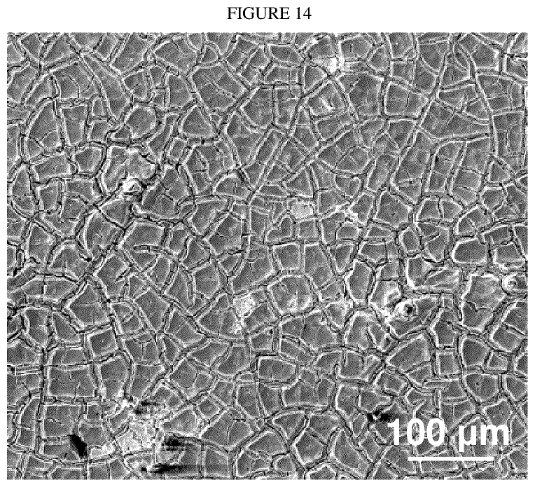

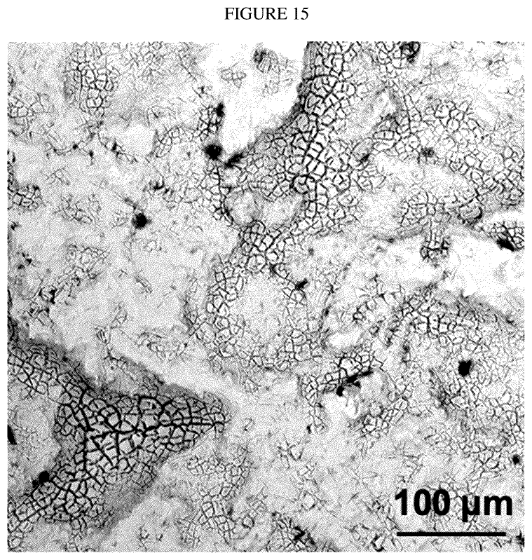

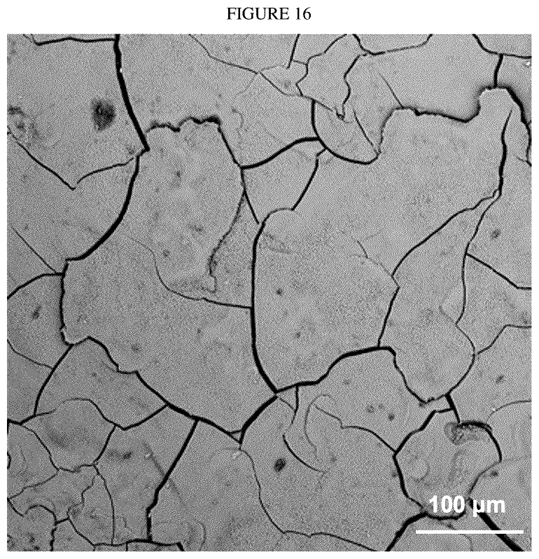

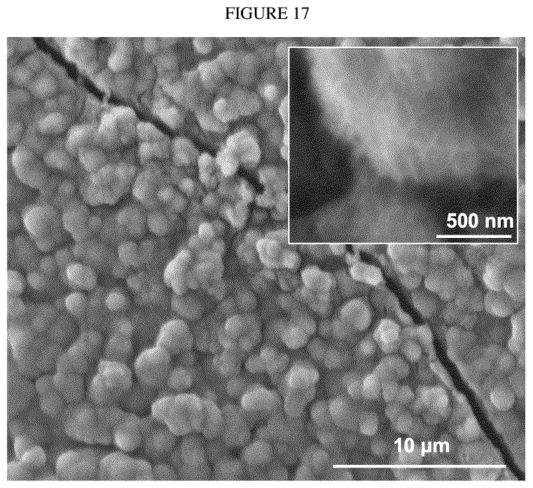

In certain preferred embodiments, the outer layer has a surface morphology comprising spheres. In further preferred embodiments, the spheres have a diameter in the nanometer range. In other preferred embodiments, the spheres have a diameter in the micrometer range. In certain embodiments, the spheres have a diameter from 0.01 μm to 10 μm. In certain embodiments, the spheres have a composition as defined in the present disclosure (e.g., the spheres comprise a mixed metal oxide as specified herein). In certain embodiments, the spheres comprise ramsdellite (γ-MnO₂). In some embodiments, the MMO layer has a surface morphology substantially as depicted in FIG. 14. In certain embodiments, the MMO layer has a surface morphology substantially as depicted in FIG. 15. In some embodiments, the outer layer has a surface morphology substantially as depicted in FIG. 16. In certain embodiments, the spheres have a morphology as depicted in FIG. 17. In some embodiments, the spheres have a morphology as depicted in FIG. 17. In certain preferred embodiments, the surface morphology of the outer layer increases the surface area of the outer layer by 1× to 100×.

In certain embodiments, the oxygen-selective anode further comprises a binding layer disposed between the MMO layer and the outer layer. In some embodiments, the binding layer comprises a copolymer comprising at least one unit of the first monomer and at least one unit of a second monomer, wherein the first monomer is tetrafluoroethylene, and the second monomer is sulfonated perfluorovinyl ether. In certain embodiments, the binding layer comprises a sulfonated tetrafluoroethylene copolymer. In some embodiments, the binding layer comprises a compound having a CAS registry number 66796-30-3.

In certain embodiments, the MMO layer comprises Ta, Ir, and O, and the oxygen-selective anode has a lifetime of from about 1000 h to about 8000 h measured at an operating current density of about 300 A/m². In some embodiments, the MMO layer comprises Ta, Ir, and O, and the oxygen-selective anode has a lifetime of about 7353 h.

In certain embodiments, the oxygen-selective anode has a selectivity for OER of greater than about 97%. In some embodiments, the oxygen-selective anode has a selectivity for OER from about 97% to about 99%. In preferred embodiments, the oxygen-selective anode has a selectivity for OER of greater than about 99%.

In certain embodiments, the outer layer has a surface having a mean area roughness (Sa) of from about 1 μm to about 10 μm. In further embodiments, the outer layer preferably has a surface having a mean area roughness (Sa) of about 1.27 μm, about 2 μm, about 4 μm, or about 10 μm.

In certain embodiments, the outer layer has a surface that is substantially flat (e.g., homogeneous). In further embodiments, the outer layer has a surface having a mean area roughness (Sa) of from 0 μm to about 1 μm. In further embodiments, the outer layer has a surface having a mean area roughness (Sa) of about 0.1 μm, about 0.2 μm, about 0.5 μm, or about 1 μm.

In certain embodiments, the substrate is solid (e.g., non-porous). In other embodiments, the substrate is porous. In some embodiments, the substrate is a plate, mesh, felt, foam, fiber, and particle, or a combination thereof. In some embodiments, the substrate is a plate. In certain embodiments, the substrate is a mesh. In some embodiments, the substrate is a felt. In some embodiments, the substrate is a foam. In some embodiments, the substrate is a fiber. In some embodiments, the substrate is a particle. In some embodiments, the substrate is a combination of a plate, mesh, felt, foam, fiber, or particle.

### PGM-Free Anodes

In spite of the long lifetimes of PGM-based electrodes, PGM metals have a low abundance in the earth's crust, and Ir is the rarest of the PGMs. Therefore, PGM-free anodes are desirable to complement the PGM-based electrodes.

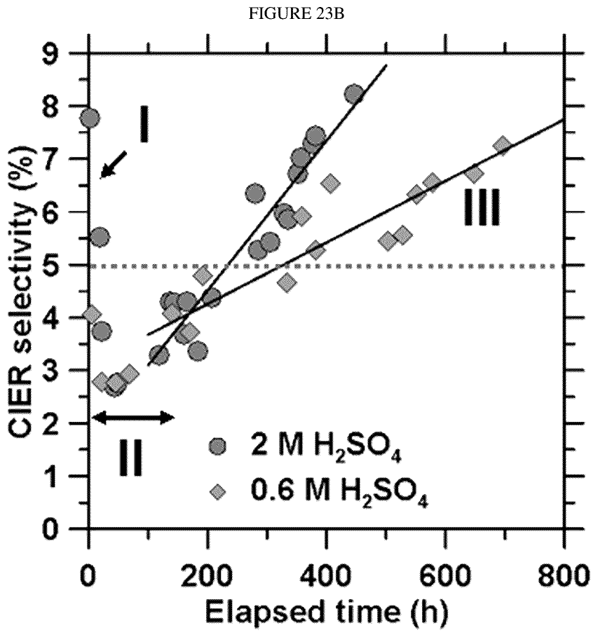

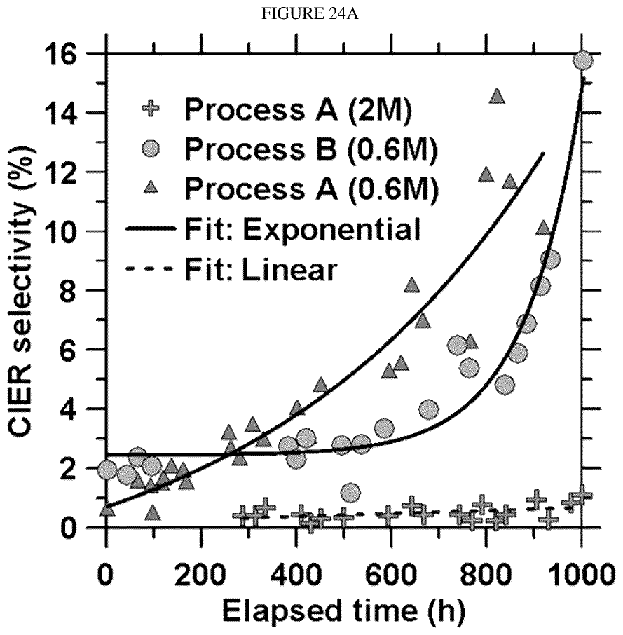

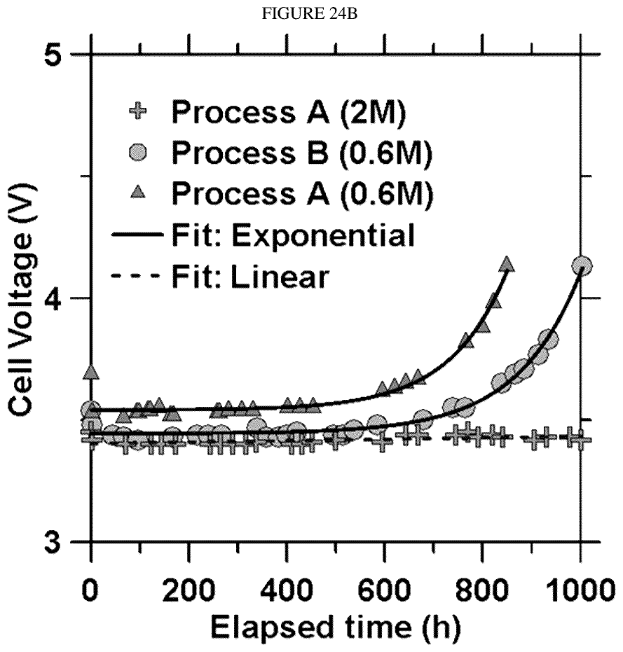

As indicated by Table 2, Co- and Mn-based catalysts have been identified as components of durable catalysts that can be used in acidic environments. Therefore, the PGM-free anodes described herein also adopt the double-layer structure used with success in the PGM-based electrodes described above, but with the TaIrOx-based OER-catalyst layer replaced by, e.g., a CoMnOx catalyst. As depicted in FIG. 24A, two processes have been trialed to fabricate PGM-free anodes, with the primary difference being whether to add Nafion as a binder of the CoMnOx catalyst and Cl⁻-blocking layer. In addition, two distinct MnOx morphologies were tested, which were imparted by varying the H₂SO₄ concentration used in the electroplating process, as discussed above and in Example 5 (see also FIG. 23A).

Preliminary durability tests for PGM-free anodes were carried out under a lower current density of 150 A/m². This is because CoMnOx and the most similar transition metal (e.g., Ni, Fe) oxides undergo redox reactions at the more anodic potentials, leading to the decomposition of the catalysts. For instance, solid MnO₂ can be oxidized to soluble permanganate ions (MnO₄⁻) at high potentials. Even in Cl⁻-free environments, PGM-free catalysts are usually operated at low current densities (≤100 A/m²)—an order of magnitude lower than that of PGM-catalysts (>1000 A/m², see Table 1-2).

The degradation behavior of PGM-free anodes differs from the PGM-based anodes. For the case of anodes made by Process A, having a lower H₂SO₄ concentration during electroplating, the ClER selectivity evolution exhibited an initial steady-state but increased exponentially (FIG. 24A) thereafter. A similar trend was observed in cell voltage evolutions (FIG. 24A), wherein the sudden increase in cell voltage indicates the deactivation of the CoMnOx catalyst. Notably, the cell voltage was stable up to 600 hours while the ClER selectivity increased very early on, implying the CoMnOx deactivation is likely caused by Cl⁻ and free chlorine species induced by a damaged MnOx layer. Therefore, it is important to improve the MnOx layer's integrity so it can better protect the underlying CoMnOx. Preliminary results indicate that modifying the concentration of the acid in the electroplating precursor resulted in a MnOx layer that is much more compatible with CoMnOx, yielding a significantly lower ClER selectivity (<1%, see FIG. 24A and FIG. 24B, sample Process A). The cell voltage of the same sample has been measured for more than 800 hours without signs of CoMnOx deactivation. In addition, adding Nafion as the binder (Process B) slightly improves the stability, but the ClER selectivity was on the same order as Process A, and the upsurge in ClER selectivity at >600 hours also led to the cell potential increase as shown in FIG. 24B.

In certain embodiments, the MMO layer comprises Co, Mo, Sn, and O. In some embodiments, the first metal oxide comprises Co, the second metal oxide comprises Mo, and the third metal oxide comprises Sn.

In some embodiments, the outer layer further comprises an outer layer dopant. In certain embodiments, the outer layer further comprises two or more outer layer dopants. In certain preferred embodiments, each of the outer layer dopants is a transition metal. In some preferred embodiments, the outer layer dopant is selected from a transition metal oxide, a transition metal hydroxide, and transition metal oxyhydroxide.

In certain embodiments, the outer layer is coated on the surface of the MMO layer.

In some embodiments, the outer layer is coated in-mix (e.g., intermingled) with the MMO layer.

In certain embodiments, the MMO layer comprises one or more additional MMO layers. In some embodiments, the MMO layer comprises 1 additional MMO layer. In certain embodiments, the MMO layer comprises 2 additional MMO layers. In some embodiments, the MMO layer comprises 3 additional MMO layers. In certain embodiments, the MMO layer comprises 4 additional MMO layers. In some embodiments, the MMO layer comprises 5 additional MMO layers. In certain embodiments, the additional MMO layer(s) comprises an element selected from groups 3, 4, 5, 6, 7, 8, 9, 10, 11, 12, 13, and 14. In further embodiments, the additional MMO layer(s) comprises a metal oxide comprising Ta, Ru, Ti, Y, Sr, Sn, La, Ce or Ir. In certain preferred embodiments, the additional MMO layer(s) has a composition as defined in the present disclosure.

In certain embodiments, the substrate is contacted with the MMO layer at a substrate-MMO junction, and the MMO layer is contacted with the outer layer at a MMO-outer layer junction. In some embodiments, the substrate-MMO junction is substantially flat. In other embodiments, the substrate-MMO junction is substantially rough. In some embodiments, the substrate-MMO junction is a bulk heterojunction. In certain embodiments, the MMO-outer layer junction is substantially flat. In other embodiments, the MMO-outer layer junction is substantially rough. In certain embodiments, the MMO-outer layer junction is a bulk heterojunction.

In certain preferred embodiments, the outer layer has a surface morphology comprising spheres. In further preferred embodiments, the spheres have a diameter in the nanometer range. In other preferred embodiments, the spheres have a diameter in the micrometer range. In certain embodiments, the spheres have a diameter from 0.01 μm to 10 μm. In certain embodiments, the spheres have a composition as defined in the present disclosure (e.g., the spheres comprise a mixed metal oxide as specified herein). In certain embodiments, the spheres comprise ramsdellite (γ-MnO₂). In some embodiments, the MMO layer has a surface morphology substantially as depicted in FIG. 14. In certain embodiments, the MMO layer has a surface morphology substantially as depicted in FIG. 15. In some embodiments, the outer layer has a surface morphology substantially as depicted in FIG. 16. In certain embodiments, the spheres have a morphology as depicted in FIG. 17. In some embodiments, the spheres have a morphology as depicted in FIG. 17. In certain preferred embodiments, the surface morphology of the outer layer increases the surface area of the outer layer by 1× to 100×.

In certain embodiments, the oxygen-selective anode further comprises a binding layer disposed between the MMO layer and the outer layer. In some embodiments, the binding layer comprises a copolymer comprising at least one unit of the first monomer and at least one unit of a second monomer, wherein the first monomer is tetrafluoroethylene, and the second monomer is sulfonated perfluorovinyl ether. In certain embodiments, the binding layer comprises a sulfonated tetrafluoroethylene copolymer. In some embodiments, the binding layer comprises a compound having a CAS registry number 66796-30-3.

In certain embodiments, the MMO layer comprises Co, Mn, and O, and the oxygen selective anode has a lifetime of from about 300 h to over 1000 h measured at a current density of about 150 A/m². In some embodiments, the MMO layer comprises Co, Mn, and O, and the oxygen selective anode has a lifetime of about 500 h measured at an operating current density of about 300 A/m^{2.}.

In certain embodiments, the oxygen-selective anode has a selectivity for OER of greater than about 97%. In some embodiments, the oxygen-selective anode has a selectivity for OER from about 97 to about 99%. In preferred embodiments, the oxygen-selective anode has a selectivity for OER of greater than about 99%.

In certain embodiments, the outer layer has a surface having a mean area roughness (Sa) of from about 1 μm to about 10 μm. In further embodiments, the outer layer preferably has a surface having a mean area roughness (Sa) of about 1.27 μm, about 2 μm, about 4 μm, or about 10 μm.

In certain embodiments, the outer layer has a surface that is substantially flat (e.g., homogeneous). In further embodiments, the outer layer has a surface having a mean area roughness (Sa) of from about 0 μm to about 1 μm. In further embodiments, the outer layer has a surface having a mean area roughness (Sa) of about 0.1 μm, about 0.2 μm, about 0.5 μm, or about 1 μm.

In certain embodiments, the substrate is solid (e.g., non-porous). In other embodiments, the substrate is porous. In some embodiments, the substrate is a plate, mesh, felt, foam, fiber, and particle, or a combination thereof. In some embodiments, the substrate is a plate. In certain embodiments, the substrate is a mesh. In some embodiments, the substrate is a felt. In some embodiments, the substrate is a foam. In some embodiments, the substrate is a fiber. In some embodiments, the substrate is a particle. In some embodiments, the substrate is a combination of a plate, mesh, felt, foam, fiber, or particle.

### CO₂ Mineralization and Removal Using Alkaline Solutions

Saline water (e.g., seawater) alkalization can be induced at overpotentials (e.g., ≤0.5 V) that yields locally-produced alkalinity (e.g., OH⁻ ions) at the cathode as a result of the hydrogen evolution reaction (HER):

2H₂O₍ₗ₎+2e⁻→H_{2(g)}+2OH_{(aq)}⁻ (5)

The reaction not only produces hydrogen that can be collected as a clean fuel, it also produces alkalinity that can then react with atmospheric or concentrated CO₂ (e.g., 400 ppm to 100%):

CO₂+OH⁻→HCO₃⁻ (6)

CO₂+2OH⁻→CO₃²⁻+H₂O (7)

Alternatively, with the presence of multi-valent cations (e.g., Ca²⁺, Mg²⁺), the alkalinity (OH⁻ ions) combined with CO₂ overcomes the barriers to Ca- and Mg-based mineral precipitation. The net reaction for calcium and magnesium ions are:

Ca₂₊+CO₂+2OH⁻→CaCO₃+H₂O (8)

Mg²⁺+CO₂+2OH⁻→MgCO₃+H₂O (9)

In many cases, CO₂ is trapped in the solid carbonate and/or hydroxycarbonate forms. On the other hand, the precipitation of calcium and magnesium carbonate could be kinetically limited at low DIC concentrations (e.g., <10 mM), thus, alkalinity can also force the precipitation hydroxides according to the following reactions:

Ca²⁺+2OH⁻→Ca(OH)₂+H₂O (10)

Mg²⁺+2OH⁻→Mg(OH)₂+H₂O (11)

whose dissolution in water (e.g., seawater), can also result in atmospheric or concentrated CO₂ (400 ppm to 100%) drawdown as HCO₃⁻/CO₃²⁻ ions (as indicated in Reactions 6-7). Strategies and conditions (e.g., direct hydroxide carbonation) for the formation of calcium and magnesium carbonates and hydroxycarbonates, e.g., calcite (CaCO₃), aragonite (CaCO₃), nesquehonite (MgCO₃·3H₂O), and hydromagnesite (Mg₅(CO₃)₄(OH)₂·4H₂O) can also be exploited, thereby resulting in solid CO₂ mineralization. In other embodiments, carbon are trapped in the dissolved (i.e., HCO₃⁻/CO₃²⁻ ions) form, whereby less alkalinity (OH⁻) are needed for every mole of CO₂ mineralized. These conditions can be achieved by equilibrating the alkalinized saline water with air (i.e., 400 ppm CO₂) or concentrated CO₂ streams (400 ppm to 100%), yielding two limiting cases: (1) solid carbonate/hydroxycarbonates production (i.e., 100% solid CO₂ sequestration), and (2) aqueous CO₂ sequestration. Following the former, 1 mol of CO₂ is captured by 2 mol of hydroxyl ions (OH⁻) to produce 1 mol CaCO₃, MgCO₃ or other alkali metal (e.g., Na, K, etc.) carbonates. In case of the latter, every mol of hydroxide ions (OH−) leads to the absorption of 1-2 mol of CO₂ to form aqueous HCO₃⁻/CO₃²⁻ ions. The CO₂ immobilization can be implemented by using carbonation reactors, or by deploying the alkaline products (solids and solutions) on land and/or ocean allowing for atmospheric CO₂ drawdown. In any case, products from CO₂ immobilization should fall within the two limiting cases and yield a combination of solid and aqueous carbonate species.

### Treatment of Anodic Products

On the other hand, acid will be produced at the anode from oxygen evolution reactions (OER):

H₂O→1/2O₂+2H⁺+2e⁻ (12)

For (NaCl-containing) saline water electrolysis, chlorine evolution reactions (ClER):

2Cl⁻−2e⁻→Cl₂ (13)

competes with the OER at the anode: OER is thermodynamically more favorable (i.e., OER initiates at lower potentials) but ClER is kinetically faster as fewer electron transfers are involved. At large scales, Cl₂ evolution and the formation of free-chlorine species (e.g., Cl₂, ClO⁻, or HClO, etc.) are in general harmful and should be suppressed.

In certain embodiments, a manganese oxide-based (MnOx−) anode is used to inhibit chlorine evolution, achieving less than 25% ClER efficiency and at least 75% OER efficiency. In general, the manganese oxide-based anodes of the disclosure may be doped or functionalized with other transition metals (e.g., Ir, Ta, Ru, Pd, Sn, Pb, Mn, Co, Fe, Mo, Sn, W, Cr, Ni, or Ti), which may be present as oxides, hydroxides, oxyhydroxides, or any combinations thereof, for enhanced selectivity and durability. In addition, the manganese oxides based (MnOx−) catalysts can be directly coated (e.g., via electroplating, electrodeposition, sol-gel coating, chemical/physical deposition, sintering, etc.) on conductive or semi-conductive substrates (e.g., metals, metal oxides, metal silicates, metal carbonates, metal phosphides, metal sulfides, metal selenides, graphite, graphene, carbon nanotubes, glassy carbon, or any combination thereof). In other embodiments, the MnOx− catalysts are coated in-mix or on-top of other catalysts, e.g., transition metals, such as Ir, Ta, Ru, Pd, Sn, Pb, Mn, Co, Fe, Mo, Sn, W, Cr, Ni, or Ti etc., oxides, hydroxides, oxyhydroxides or any combinations thereof, to promote anode stability and conductivity.

In certain embodiments, as a consequence of the use of OER-selective anodes, molar equivalents of acid are produced in proportion to the amount of chlorine avoided. Accordingly, the use of a thicker porous separator between the anodic and cathodic cells performing seawater electrolysis may be necessary, as compared to a system that is evolving chlorine. In certain embodiments, the porous separator is an acid resistant, hydrophilic ceramic (e.g., aluminum oxide, zirconium oxide, silicon dioxide, asbestos, hydrous aluminum phyllosilicates, clay, or any combination thereof), polymer (e.g., cellulose, polyvinyl chloride, organic rubber, polyolefin, polyethylene, polypropylene, polyvinylidene fluoride, polytetrafluoroethylene, epoxy resin, silicone, or any combination thereof), or ceramic-polymer composite separator. The separator materials can be used as is, or be treated to enhance surface hydrophilicity. The median pore size can of the separators can range from 10 nm to 500 μm, and the thickness can range from 100 μm to 5 mm.

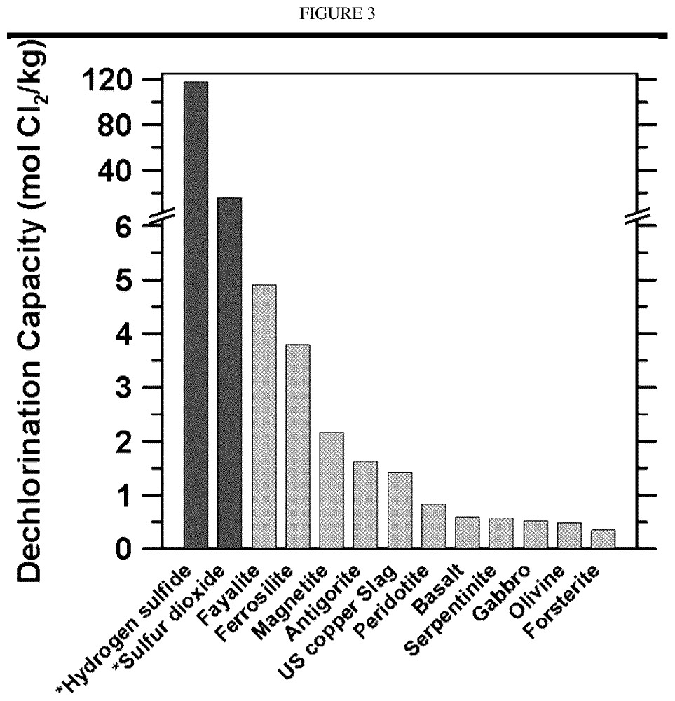

With ClER minimized upstream by OER-selective anode, the remaining chlorine and acid species in anolyte effluents may be further neutralized and/or removed (e.g., by downstream dechlorination and deacidification). In certain embodiments, based on a conservatively estimated OER efficiency of 90%, over 20-41 kilomole of H+ (in acidified anolyte) accompanied by 1.1-2.3 kilomole of Cl₂ (or the hydrolyzed free-chlorine species: HClO and ClO⁻) will be produced for every tonne of CO₂ mineralized as bicarbonates/carbonates. Providing that the cathodic alkalinity will be entirely used for CO₂ mineralization, external sources of cheap, abundant, and relatively reactive materials may be used to re-alkalinize the anolyte. Moreover, once the anolyte is neutralized to a pH>6, the evolved Cl₂ can also be retained/reabsorbed as hydrolyzed species, enabling in-solution dechlorination approaches. There is a wide range of mineral mixtures (e.g., rocks, industrial wastes) that can be used as neutralization and, optionally, further alkalinization reagents. The choice of neutralization solute is based on two material parameters: a) the acid neutralization capacity which is established by the elemental composition, and b) the dissolution rate of the material which to the first order is dictated by the solution pH. Exemplary reagents are listed in Table S1 and shown in FIG. 2 and FIG. 3. The acid neutralization capacities of the exemplary reagents span an order of magnitude (5-to-50 mol H+/kg), and some of these reagents are available in abundance in a granular form (e.g., fly ash reservoirs in the U.S. alone hold over 3 billion tonnes of residues). In addition, common ocean alkalinization minerals (e.g., those listed in Table S1) can be used to treat acidic anolyte.

Due to the strong oxidizing properties of chlorine and its hydrolyzed species (e.g., HClO, ClO⁻), free chlorine species find themselves in applications such as wastewater/gas treatments. The chlorinated anolyte can be dechlorinated via many waste treatment processes, such as 1) use in preventing biofouling of filtration membranes (e.g., the hypochlorite shock); 2) by mixing with wastewater to decontaminate organic and inorganic substances (cyanides, arsenic, heavy metals, etc.); 3) by scrubbing flue gases to oxidize harmful H₂S and SOₓ (e.g., SO₂) and NOx (e.g., NO, NO₂) gases. Moreover, the ferrous iron (Fe²⁺) or other low valent metal species (e.g., Mn, Ni, Cr, Ti, etc., or any combination thereof) naturally present in the minerals/rocks used for acid neutralization can also effectively reduce chlorine to chlorides, providing co-deacidification and dechlorination pathways. Similarly, solid industrial wastes such as copper slags are enriched in ferrous species (e.g., Fayalite) and alkali metal oxides that could potentially neutralize the acidity while reducing free chlorine (see FIG. 3).

### Modifications to Systems of the Disclosure

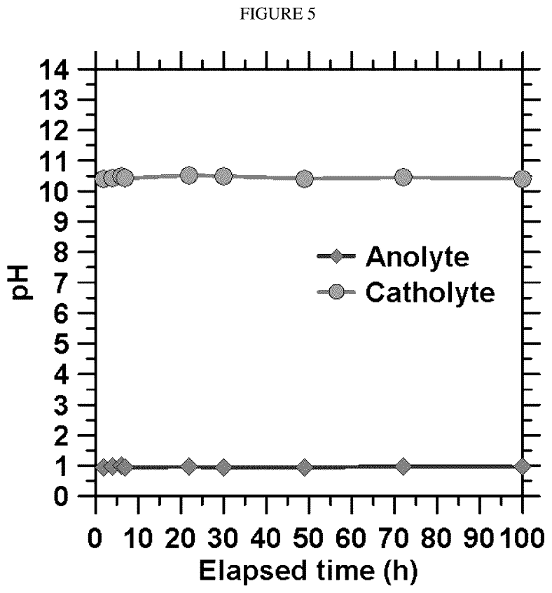

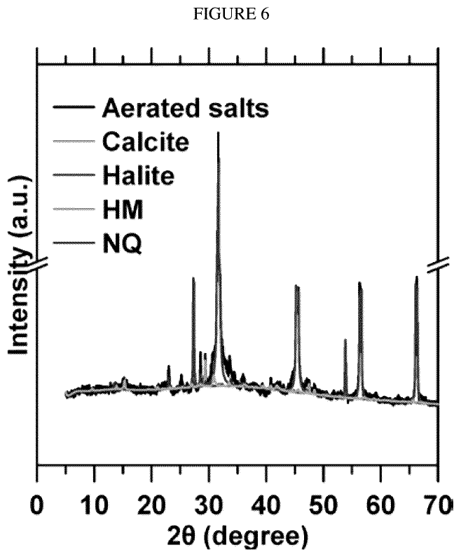

Naturally enhanced aeration or surface area enhancement of the catholyte can be conducted by disposing the catholyte and the produced hydroxide into the ocean or land to ensure effective mixing and CO₂ equilibration. If released in ocean, the catholyte may act as a seawater alkalinization reagent to promote atmospheric CO₂ drawdown and to counter ocean acidification. In certain embodiments, carbonation of the catholyte can be performed in a separate carbonator or in the alkaline process chamber using atmospheric air or more concentrated CO₂ streams. As illustrated in FIG. 5 and FIG. 6, exemplary results show aeration of the catholyte and precipitates leads to CO₂ mineralization as both solid and aqueous species, even at a CO₂ concentration as low as 400 ppm (atmospheric).

### Definitions

Unless otherwise defined herein, scientific and technical terms used in this application shall have the meanings that are commonly understood by those of ordinary skill in the art. Generally, nomenclature used in connection with, and techniques of, chemistry, chemical engineering, electrical engineering and civil engineering described herein, are those well-known and commonly used in the art.

The methods and techniques of the present disclosure are generally performed, unless otherwise indicated, according to conventional methods well known in the art and as described in various general and more specific references that are cited and discussed throughout this specification.

Chemistry terms used herein, unless otherwise defined herein, are used according to conventional usage in the art, as exemplified by “The McGraw-Hill Dictionary of Chemical Terms”, Parker S., Ed., McGraw-Hill, San Francisco, C.A. (1985).

All publications, patents and published patent applications referred to in this application are specifically incorporated by reference herein. In case of conflict, the present specification, including its specific definitions, will control.

As used herein, the terms “optional” or “optionally” mean that the subsequently described event or circumstance may occur or may not occur, and that the description includes instances where the event or circumstance occurs as well as instances in which it does not. For example, “optionally substituted alkyl” refers to the alkyl may be substituted as well as where the alkyl is not substituted.

The terms “olivine” and “olivine rock” as used herein may refer to at least one of olivine, comprising Mg, Fe, and SiO4, and any of the various members of the “Olivine Group,” which includes olivine, tephroite, monticellite, larnite and kirschsteinite. The above olivine species may further comprise other elements, such as, Mg, Fe, Mn, Al, Ti, Ca, Cr, Ni, Co. Olivine may be found in mafic and ultramafic igneous rock.

The terms “deacidifying,” “deacidify,” and “deacidification” as used herein refer to a process that results in an increase in pH of an aqueous solution.

A “deacidifying composition” herein refers to a composition that deacidifies a substrate. Deacidifying compositions include alkaline rocks and minerals containing carbonates, hydroxides, oxides, and/or silicates. As a non-limiting example, olivine rock may, in certain embodiments, be used as a deacidifying composition to deacidify a solution with a low pH.

“Free-chlorine species” as used herein may refer to any chemical compound that comprises or can generate chlorine atoms with an oxidation state greater than or equal to 0. As non-limiting examples, free-chlorine species of the disclosure include Cl₂, ClO⁻, and HClO.

The terms “dechlorinate,” and “dechlorination” as used herein refer to processes that result in the removal of Cl-containing compounds or ions from a substrate such as an aqueous solution. In preferred embodiments, as a non-limiting example, dechlorination includes the chemical conversion of free-chlorine species (e.g., Cl₂, ClO⁻, HClO, etc.) to chlorides (Cl⁻) using a dechlorinating composition.

The term “dechlorinating composition” as used herein refers to a composition that facilitates the chemical transformation of free-chlorine species into chlorides.

The term “deacidifying and dechlorinating composition” as used here refers to a composition that advantageously deacidifies (e.g., induces an increase in pH of an aqueous solution and dechlorinates (e.g., facilitates the chemical transformation of free-chlorine species into chlorides) an aqueous solution.

The term “reductive species” as used herein refers to a chemical species which may interact with another chemical species and transfer at least one valence electron to the chemical species, thereby reducing the chemical species. Reductive species may include, but are not limited to, low-valent metallic species.

The term “low-valent metallic species” as used herein refers to chemical species, which exists in a formal oxidation state less than (i.e., lower than) at least one of the most common naturally-occurring non-zero oxidation states. As non-limiting examples, low-valent metal species described herein may include Fe⁰, Fe²⁺, Mn⁰, Mn³⁺, Mn⁴⁺, Ni⁰, Ni⁺, and Ni³⁺.

The term “alkalinizing” as used herein refers to a process of increasing the pH of a given solution, e.g., alkalinizing the first solution to prepare an alkaline solution with a higher pH.

The term “acidifying” or “acidification” as used herein refers to a process of decreasing the pH of a given solution. The given solution may be of any starting pH before undergoing the acidifying, e.g. the solution may already have a pH below 7 before a step of acidifying the solution is performed.

The term “ionic communication” as used herein refers to the ability for ions to freely flow between two objects or regions of an object, e.g., between the cathodic chamber and anodic chamber of an electrochemical cell, in accordance with local chemical gradients. Non-limiting examples of such gradients include flow of ions from an area of high electrical potential to low electrical potential, from high ion concentration to low ion concentration, and from high chemical potential to low chemical potential. In certain embodiments, two objects or regions may be physically separated by a semi-permeable barrier (e.g., not in fluid communication) but still be in ionic communication, e.g., by virtue of ion diffusion or transport through the barrier.

The term “homogeneous” when used herein to describe a surface, refers to a substantially flat or featureless surface, e.g., a surface having low mean area roughness (Sa). For example, a homogeneous surface of the disclosure may have a mean area roughness (Sa) of about 1.2 μm.

The term “particulate” when used herein to describe a surface, refers to a surface having particles (e.g., spheres) dispersed on the surface and/or adhered to it, such that the surface comprises the particles. For example, certain particulate surfaces of the disclosure consist essentially of MnOx spheres. Particulate surfaces of the disclosure will be more rough (e.g., have a higher mean area roughness, Sa) than homogeneous surfaces of the disclosure.

The terms “mean area roughness” and “Sa” as used herein refer to a 3-dimensional roughness measurement which represents the average roughness over a measurement area. The value of Sa is the arithmetical mean of the respective distances of a collection of points in the sample measurement (e.g., points on the anode surface) from a “mean plane” representing the average plane of all points in the measurement. Higher Sa values indicate that a surface is “more rough,” or has a greater average absolute distance from the mean plane. Conversely, lower values of Sa indicate that a surface is “less rough,” or more flat.

### EXAMPLES

The invention now being generally described, it will be more readily understood by reference to the following examples which are included merely for purposes of illustration of certain aspects and embodiments of the present invention, and are not intended to limit the invention.

### Example 1: Exemplary Deacidifying Agents

TABLE S1
List of exemplary deacidifying agents, their descriptions,
and approximate moles of H⁺ neutralized per kg of agent.

| | | Mol H⁺ neutralized |
|---|---|---|
| Deacidifying | | per kg deacidifying |
| Agent | Description | agent |
| Periclase | MgO, a mineral found in metamorphic rocks | 49.63 |
| Lime | CaO, naturally occurring or synthetic | 35.66 |
| Lime Kiln Dust | By-product of lime manufacturing | 34.38 |
| Forsterite | Mg₂SiO₄, the Mg-endmember of olivine | 28.43 |
| Olivine | Group of nesosilicate minerals found in | 25.97 |
| | ultramafic rocks | |
| Larnite | Ca₂SiO₄, a nesosilicate found in crystalline | 23.22 |
| | slags | |
| Serpentinite | Ultramafic rock rich in serpentine, a | 22.96 |
| | hydrothermal alteration product of olivine | |
| Basalt | Fine-grained mafic rock rich in plagioclase | 22.91 |
| | feldspar and pyroxene | |
| Stainless steel slag | Semicrystalline by-product of metal | 22.02 |
| | manufacturing | |
| Peridotite | Ultramafic rock rich in olivine with some | 22.00 |
| | pyroxene | |
| Lizardite | Mg₃(Si₂O₅)(OH)₄, a phyllosilicate | 21.65 |
| (Serpentine) | | |
| Ladle slag | Semicrystalline by-product of metal | 20.40 |
| | manufacturing | |
| Blast furnace slag | Semicrystalline by-product of metal | 19.97 |
| | manufacturing | |
| Diopside | CaMgSi₂O₆, a single-chained inosilicate | 18.47 |
| | (pyroxene) | |
| Air-cooled blast | Crystalline by-product of metal | 17.78 |
| furnace slag | manufacturing | |
| Wollastonite | CaSiO₃, a single-chained inosilicate | 17.22 |
| Basic oxygen | Semicrystalline by-product of metal | 16.85 |
| furnace slag | manufacturing | |
| Brownmillerite | Ca₂(Al,Fe³⁺)₂O₅, a non-stoichiometric | 16.66 |
| | perovskite | |
| Comingled electric | Semi-crystalline by-product of metal | 16.64 |
| arc furnace slag | manufacturing | |
| Cement kiln dust | Amorphous by-product of Ordinary Portland | 15.94 |
| | Cement (OPC) production | |
| Talc | Mg₃Si₄O₁₀(OH)₂, a phyllosilicate | 15.82 |
| Electric arc | Semi-crystalline by-product of metal | 15.08 |
| furnace slag | manufacturing | |
| Class C fly ash | High-calcium fly ash from processing | 13.59 |
| | subbituminous and lignite coals | |
| Reclaimed Class C | High-calcium fly ash reclaimed from landfill | 13.45 |
| fly ash | | |
| Anorthite | CaAl₂Si₂O₈, Ca-endmember of plagioclase | 9.61 |
| | feldspar, a tectosilicate | |
| Trona-rich fly ash | Fly ash containing Na₃(CO₃)(HCO₃)•2H₂O | 9.44 |
| Bytownite | Na_{0.2}Ca_{0.8}Al_{1.8}Si_{2.2}O₈, a type of plagioclase | 6.55 |
| | feldspar, a solid solution of NaAlSi3O8 and | |
| | CaAl2Si2O8 | |
| Gabbro | Coarse-grained mafic rock rich in plagioclase | 6.48 |
| | feldspar and pyroxene | |
| Anorthosite | Fine-grained mafic rock rich in anorthite | 5.65 |
| Albite | NaAlSi₃O₈, Na-endmember of plagioclase | 3.80 |
| | feldspar, a tectosilicate | |
| Class F fly ash | Low-calcium fly ash from processing | 1.91 |
| | anthracite and bituminous coals | |

### Example 2: Results of an Exemplary CO₂ Removal System

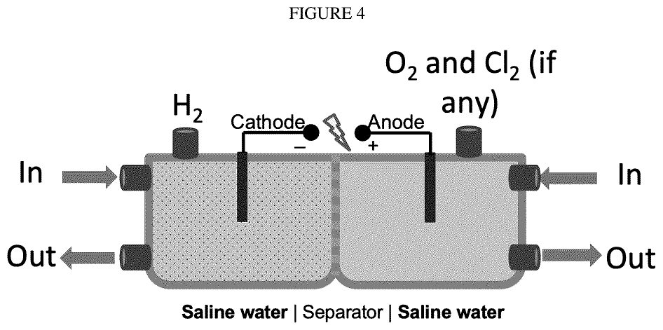

An exemplary two-chamber flow-through reactor (e.g., FIG. 4) was employed with a porous diaphragm used to separate the anolyte and catholyte. Seawater was used to flow through the anolyte and catholyte chambers. 316 stainless steel mesh was used as the cathode, while a MnOx-coated titanium anode of the present disclosure was used as the anode. In the aforementioned set up, flowrates of catholyte and anolyte were identical and were controlled by a peristaltic pump. The catholyte pH was maintained at above 10 and the anolyte pH is below 2 through the application of a voltage to the electrode pair (FIG. 5).

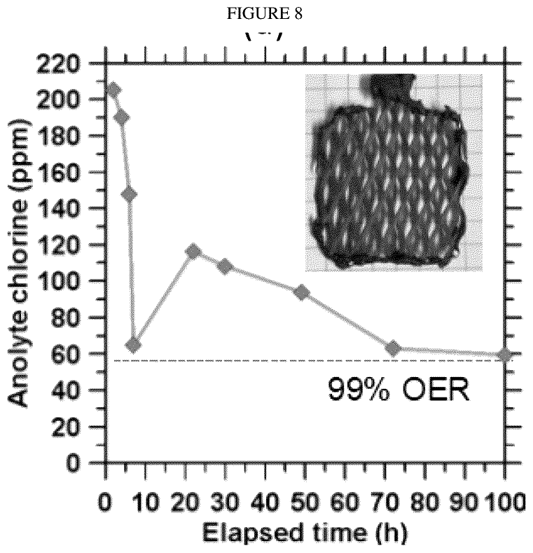

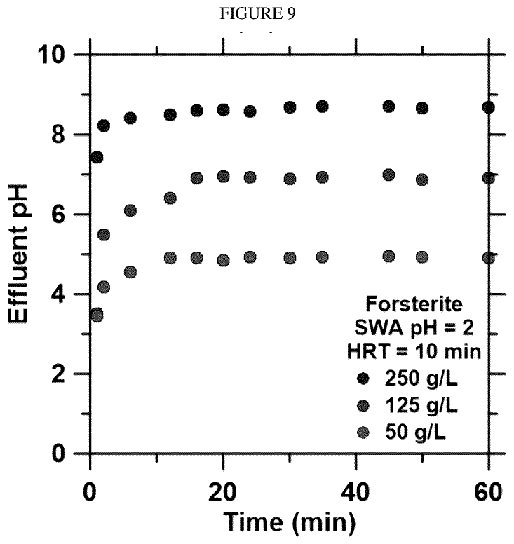

As for anolyte treatment, the use of the manganese oxide-coated anode (FIG. 8, inset) significantly reduced chlorine oxidation during the electrolysis process to approximately 99% (FIG. 8). The remaining free-chlorine species (<100 ppm) can be easily dechlorinated by aforementioned approaches or by using commercial reagents (e.g., activated carbon, SO₂, sulfite salts, etc.), rendering the grand carbon removal process free from generating oxidized chlorine species. In addition, FIG. 9 shows exemplary results of neutralizing the anolyte acidity by using an olivine rock (forsterite). Note that, >99% of the acidity (H+) were neutralized even at a low solid loading (50 g/L) under a hydraulic retention time of 10 mins.

### Example 3: Synthesis of Exemplary Oxygen-Selective Anodes

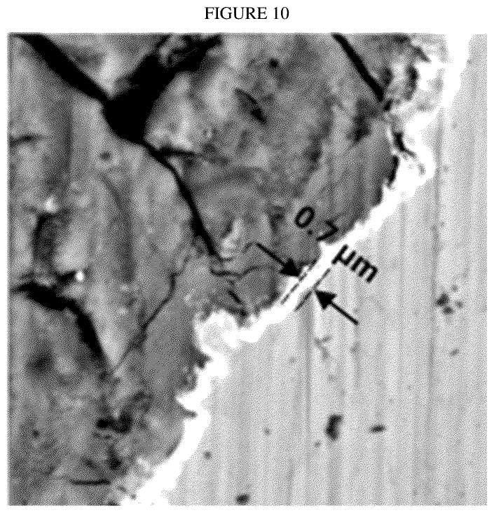

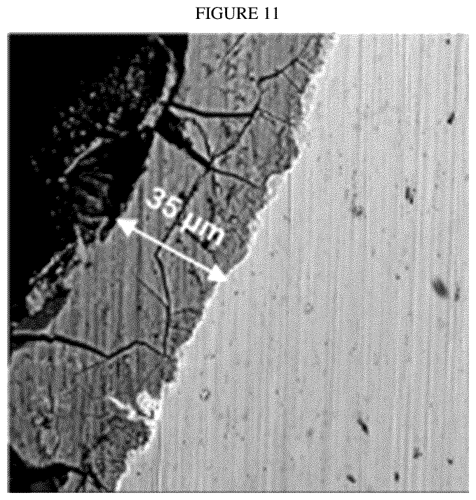

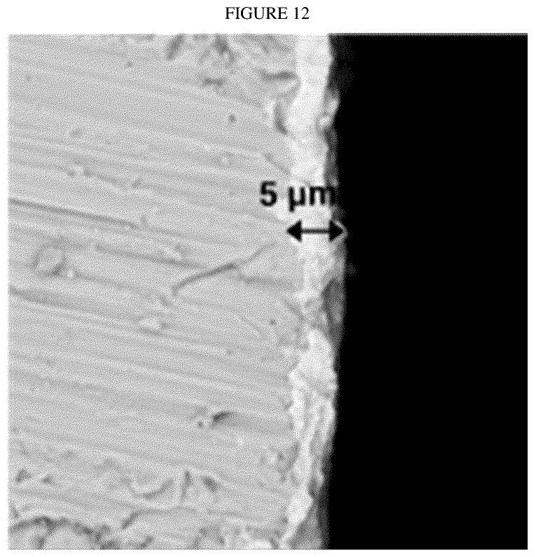

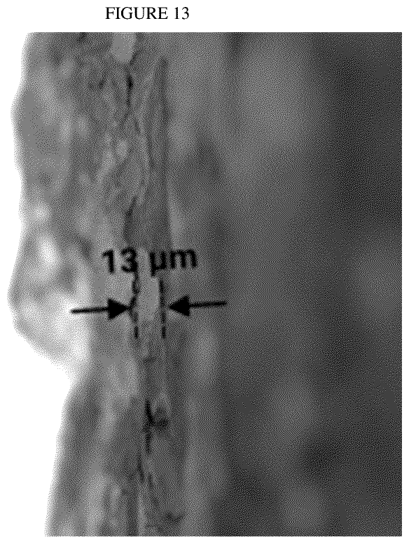

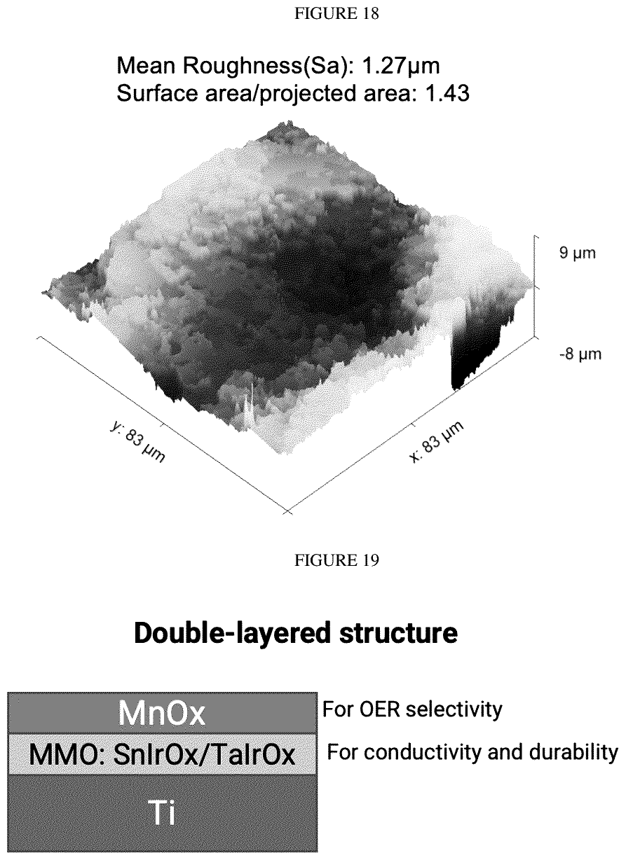

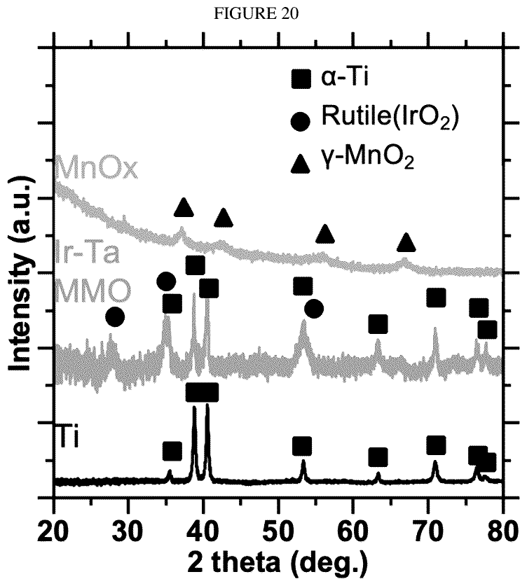

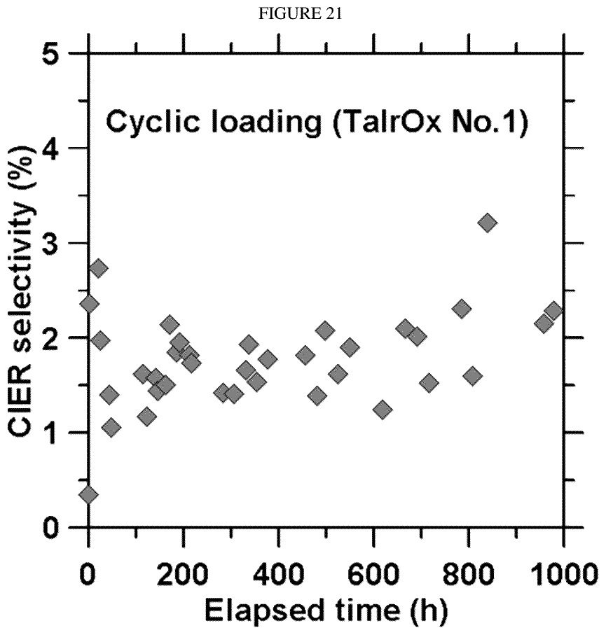

The exemplary OER-selective anodes (shown in FIGS. 10-16) were fabricated by depositing a mixture of Mn, Mo, and Sn oxides on top of a titanium metal substrate coated with a layer of mixed metal oxides (MMO). The MMO intermediate layer was composed of a mixture of IrO₂ and SnO₂ (namely, Ir—Sn MMO, see FIGS. 10 and 14), or a mixture of IrO₂ and Ta₂O₅ (namely, Ir—Ta MMO, see FIGS. 12 and 15). The titanium substrates coated with Ir—Sn MMO or Ir—Ta MMO were subsequently placed in an electrodeposition bath solution comprising H₂SO₄, MnSO₄, Na₂MoO₄, and SnCl₄. Pt-coated titanium meshes were also placed in the bath as the cathode, and a porous hydrophilic PVDF, or a porous ceramic separator/diaphragm were placed in between the MMO-coated Ti (anode) and the Pt-coated Ti (cathode). Thereafter, the bath was heated to 90° C. and the MMO-coated Ti was anodically polarized to achieve a current density of 600 A/m² for 30 minutes. The electrodeposition procedure was repeated as needed with the bath solution replaced in between each time. Consequently, this procedure generally results in MnOx coatings of from about 0.1 μm to about 50 μm thick, that grow on top of the MMO coatings (see FIGS. 11, 13, and 16-20). X-Ray Diffraction (XRD) (FIG. 20) characterizations shows the MnOx coating is composed of ramsdellite (γ-MnO₂), with an Ir—Ta layer having a rutile structure. High-resolution SEM images (FIG. 17) characterizations shows ramsdellite (γ-MnO₂) is in the form of micro-spheres with diameters ranging from 0.79-2.3 μm. As shown in FIG. 18, the γ-MnO₂ microspheres contribute to an expansion of surface area ˜1.5 times compared to the geometrical surface area. The γ-MnO₂ spheres feature nanostructured surfaces that increase the electrode-electrolyte contact area.

### Example 4: Synthesis of Exemplary Oxygen-Selective Anodes

The exemplary OER-selective anodes (shown in FIGS. 10-16) were fabricated by depositing Mn oxides on top of a titanium metal substrate coated with a layer of mixed metal oxides (MMO). The MMO intermediate layer was composed of a mixture of IrO₂, SnO₂, and Ta₂O₅ (namely, Ir—Ta MMO, see FIGS. 12 and 15). The titanium substrates coated with Ir—Ta—Sn MMO were subsequently placed in an electrodeposition bath solution comprising H₂SO₄ and MnSO₄. Pt-coated titanium meshes were also placed in the bath as the cathode, and a porous hydrophilic PVDF, or a porous ceramic separator/diaphragm were placed in between the MMO-coated Ti (anode) and the Pt-coated Ti (cathode). Thereafter, the bath was heated to 90° C. and the MMO-coated Ti was anodically polarized to achieve a current density of 600 A/m² for 30 minutes. The electrodeposition procedure was repeated as needed with the bath solution replaced in between each time. Consequently, this procedure generally results in MnOx coatings of from about 0.1 μm to about 50 μm thick, that grow on top of the MMO coatings (see FIGS. 11, 13, and 16-20). X-Ray Diffraction (XRD) (FIG. 20) characterizations shows the MnOx coating is composed of ramsdellite (γ-MnO₂), with an Ir—Ta—Sn layer having a rutile structure. High-resolution SEM images (FIG. 17) characterizations shows ramsdellite (γ-MnO₂) is in the form of micro-spheres with diameters ranging from 0.79-2.3 μm. As shown in FIG. 18, the γ-MnO₂ microspheres contribute to an expansion of surface area ˜1.5 times compared to the geometrical surface area. The γ-MnO₂ spheres feature nanostructured surfaces that increase the electrode-electrolyte contact area. The nanostructured γ-MnO₂ spheres predominate the surface if using a low H₂SO₄ concentration (e.g., 0.1 to about 1.9 M) in the plating bath, whereas the high H₂SO₄ concentration (about 2 M to about 6 M, up to about 18 M) plating bath promotes a more flat (homogeneous) MnOx coating surface (FIG. 23A).

### Example 5: ALT Testing of Exemplary Anodes with Varying Morphologies

The H₂SO₄ content in the electroplating precursor was varied, and ALT experiments were conducted, to observe the impact the MnOx coating composition and morphology. A series of selected H₂SO₄ concentrations between about 0.1 and about 18M were tested in the plating bath. The resultant ALT lifetime and predicted lifetime values were discretized into the following categories: ALT lifetime: + (100 h-300 h); ++ (300 h-600 h), +++ (600 h-900 h), and ++++ (900 h-1200 h); predicted lifetime: * (1000 h-3000 h), ** (3000 h-5000 h), *** (5000 h-7000 h), and **** (7000 h-9000 h). Exemplary results are provided in Table 4 for anodes having a substantially flat (homogeneous) surface, prepared by plating at higher H₂SO₄ concentrations, and for anodes having a particulate surface, prepared by plating at lower H₂SO₄ concentrations. The lower H₂SO₄ results in a particulate MnOx coating morphology, whereas the higher concentration H₂SO₄ plating bath promotes a more homogenous appearance (FIG. 23A). Preliminary ALT experiments showed the two coatings behave very similarly up to about the 200 hour mark (including stage I, stage II, and the beginning of stage III), but the anode with the particulate coating exhibits a slower degradation rate towards the end of stage III. If given a (arbitrary) threshold of ClER selectivity of 5%, the ALT life is determined as + for cyclic and constant voltage conditions, respectively, leading to a predicted lifetime in the * category. The combination of the homogeneous MnOx layer with substrate 3 yielded the best performance in the Accelerated Lifetime Testing.

The ALT (experimental) lifetimes and predicted lifetimes of the tested electrodes are tabulated in Table S5:

TABLE S5
ALT life and predicted OER life for exemplary PGM-based anodes.

| ALT Test ID | ALT-1 | ALT-2 | ALT-3 | ALT-4 |
|---|---|---|---|---|
| MnOx morphology | homogeneous | homogeneous | homogeneous | particulate |
| Voltage loading | cyclic | constant | constant | constant |
| Substrate | 2 | 2 | 3 | 2 |
| ALT life (h) | + | + | ++++ | ++ |
| Predicted life (h) | * | * | **** | * |

### INCORPORATION BY REFERENCE

All publications and patents mentioned herein are hereby incorporated by reference in their entirety as if each individual publication or patent was specifically and individually indicated to be incorporated by reference. In case of conflict, the present application, including any definitions herein, will control.

### EQUIVALENTS

While specific embodiments of the subject invention have been discussed, the above specification is illustrative and not restrictive. Many variations of the invention will become apparent to those skilled in the art upon review of this specification and the claims below. The full scope of the invention should be determined by reference to the claims, along with their full scope of equivalents, and the specification, along with such variations.

1-273. (canceled)

274. An oxygen-selective anode comprising:
a substrate;
a mixed metal oxide (MMO) layer disposed on the substrate; and
an outer layer disposed on the MMO layer;
wherein:
the substrate comprises a conductive or semi-conductive material;
the MMO layer comprises at least one element selected from the elements of groups 3, 4, 5, 6, 7, 8, 9, 10, 11, 12, 13 and 14; and
the outer layer comprises manganese and oxygen.

275. A method of acidifying an aqueous solution, comprising contacting the aqueous solution with an oxygen-selective anode, thereby forming H⁺ and/or H₃O⁺ ions and O₂ at the anode, wherein the oxygen selective anode comprises:
a substrate;
a mixed metal oxide (MMO) layer disposed on the substrate; and
an outer layer disposed on the MMO layer;
wherein:
the substrate comprises a conductive or semi-conductive material;
the MMO layer comprises at least one element selected from the elements of groups 3, 4, 5, 6, 7, 8, 9, 10, 11, 12, 13 and 14; and
the outer layer comprises manganese and oxygen.

276. A method of sequestering CO₂ comprising:
(a) in a first cathodic chamber, performing an alkaline process comprising:
(i) alkalinizing a first solution by contacting the first solution with a cathode disposed inside of the first cathodic chamber, thereby forming an alkaline solution and H₂, wherein the first solution comprises water;
(ii) contacting the alkaline solution with a CO₂ source, thereby forming a carbonated solution comprising a mixture of ionic compounds, wherein the ionic compounds comprise CO₃²⁻ or HCO₃⁻;
(b) in a first anodic chamber, performing an acidic process comprising:
(i) acidifying a second solution comprising chloride ions by contacting the second solution with an oxygen-selective anode disposed inside the first anodic chamber, thereby forming an acidic solution; and
(ii) deacidifying the acidic solution by contacting the acidic solution with a deacidifying agent, thereby forming a deacidified solution; and
(c) dechlorinating the acidic solution or deacidified solution by contacting the acidic solution or the deacidified solution with a dechlorinating agent;
wherein:
the first anodic chamber and the first cathodic chamber are in ionic communication;
the acidic process and the alkaline process are performed simultaneously or sequentially; and
the oxygen selective anode comprises:
a substrate;
a mixed metal oxide (MMO) layer disposed on the substrate; and
an outer layer disposed on the MMO layer;
further wherein:
the substrate comprises a conductive or semi-conductive material;
the MMO layer comprises at least one element selected from the elements of groups 3, 4, 5, 6, 7, 8, 9, 10, 11, 12, 13 and 14; and
the outer layer comprises manganese and oxygen.

277. The method of claim 276, wherein the first solution further comprises univalent alkali ions or divalent alkaline earth ions.

278. The method of claim 276, wherein the first solution further comprises polyvalent alkaline earth ions.

279. The method of claim 276, wherein the carbonated solution further comprises a mixture of carbonate solids.

280. The method of claim 276, wherein the alkaline process and acidic process are performed simultaneously.

281. The method of claim 276, wherein the deacidifying agent is selected from Periclase, Lime, Lime Kiln Dust, Forsterite, Olivine, Larnite, Serpentinite, Basalt, Stainless steel slag, Peridotite, Lizardite (Serpentine), Ladle slag, Blast furnace slag, Diopside, Air-cooled blast furnace slag, Wollastonite, Basic oxygen furnace slag, Brownmillerite, Comingled electric arc furnace slag, Cement kiln dust, Talc, Electric arc furnace slag, Class C fly ash, Reclaimed Class C fly ash, Anorthite, Trona-rich fly ash, Bytownite, Gabbro, Anorthosite, Albite, and Class F fly ash.

282. The method of claim 276, wherein the dechlorinating agent is selected from Hydrogen sulfide, Sulfur dioxide, Sulfite salts, Copper slag, Fayalite, Ferrosilite, Magnetite, Antigotite, Periclase, Lime, Lime Kiln Dust, Forsterite, Olivine, Larnite, Serpentinite, Basalt, Stainless steel slag, Peridotite, Lizardite (Serpentine), Ladle slag, Blast furnace slag, Diopside, Air-cooled blast furnace slag, Wollastonite, Basic oxygen furnace slag, Brownmillerite, Comingled electric arc furnace slag, Cement kiln dust, Talc, Electric arc furnace slag, Class C fly ash, Reclaimed Class C fly ash, Anorthite, Trona-rich fly ash, Bytownite, Gabbro, Anorthosite, Albite, and Class F fly ash.

283. The method of claim 276, wherein the deacidifying agent is the dechlorinating agent.

284. The method of claim 276, wherein the CO₂ source comprises from about 400 ppm to about 100% CO₂, preferably about 400 ppm.

285. The method of claim 276, wherein the CO₂ source is ambient air.

286. The method of claim 276, wherein the CO₂ source has a higher CO₂ concentration than ambient air, such as gaseous effluent from an industrial process, and concentrated CO₂ from direct air capture processes.

287. The method of claim 276, wherein the first solution is selected from seawater, desalination brine, industrial brine, and natural brine.

288. The method of claim 276, wherein the second solution is selected from seawater, desalination brine, industrial brine, and natural brine.

289. The method of claim 276, wherein the first solution and the second solution are from the same source solution.

290. The method of claim 276, wherein the alkaline process and acidic process occur in spaces separated by a semi-permeable barrier having a plurality of pores.

291. The method of claim 290, wherein the semi-permeable barrier is treated to enhance surface hydrophilicity.

292. The method of claim 290, wherein the plurality of pores has a median pore diameter from about 10 nm to about 500 μm.

293. The method of claim 290, wherein the semi-permeable barrier has a thickness of from about 100 μm to about 5 mm.

294. The method of claim 276, wherein the alkaline solution has a pH from about 7 to about 14.

295. The method of claim 276, wherein the acidic solution has a pH from about 0.1 to about 7.

296. An electrochemical cell comprising:
(a) a cathodic chamber comprising:
a cathode
an cathodic gas outlet;
a first solution inlet; and
an alkaline solution outlet;
wherein the cathode is disposed inside the cathodic chamber and coupled to a power source; and
(b) an anodic chamber comprising:
an oxygen selective anode;
an anodic gas outlet;
a second solution inlet; and
an acidic solution outlet;
wherein the oxygen selective anode is disposed inside the anodic chamber and coupled to a power source;
wherein the oxygen selective anode comprises:
a substrate;
a mixed metal oxide (MMO) layer disposed on the substrate; and
an outer layer disposed on the MMO layer;
further wherein:
the substrate comprises a conductive or semi-conductive material;
the MMO layer comprises at least one element selected from the elements of groups 3, 4, 5, 6, 7, 8, 9, 10, 11, 12, 13 and 14; and
the outer layer comprises manganese and oxygen.
